(19) United States
(12) Patent Application Publication
(10) Pub. No.: US 2025/0102453 A1
(43) Pub. Date: Mar. 27, 2025

(54) Dielectric Spectroscopy Sensor

(71) Applicant: Nippon Telegraph and Telephone Corporation, Tokyo (JP)

(72) Inventors: Masahito Nakamura, Musashino-shi, Tokyo (JP); Takuro Tajima, Musashino-shi, Tokyo (JP); Ayumi Ikeda, Musashino-shi, Tokyo (JP); Michiko Seyama, Musashino-shi, Tokyo (JP)

(21) Appl. No.: 18/726,200

(22) PCT Filed: Jan. 6, 2022
(86) PCT No.: PCT/JP2022/000238

§ 371 Date: Jul. 2, 2024

(51) Int. Cl. G01N 27/02

(52) U.S. Cl. CPC G01N 27/026

(57) ABSTRACT

The present invention includes a transmission line and a quasi-coaxial structure unit connected to the transmission line and having a first opening having a first opening diameter. The transmission line has a characteristic impedance that is the same as a characteristic impedance at a connection portion of a dielectric spectroscopy system. The present invention further includes an opening diameter adjustment unit connected to the quasi-coaxial structure unit, having one end having a predetermined characteristic impedance, and having the other end serving as a second opening having a second opening diameter different from the first opening diameter.

### TECHNICAL FIELD

The present invention relates to a dielectric spectroscopy sensor.

### BACKGROUND ART

A component concentration test such as a blood glucose level requires sampling of blood, which is a heavy burden on a patient. Therefore, a non-invasive component concentration measurement device that does not sample blood has been put into practical use.

As the non-invasive component concentration measurement device, for example, a method using an electromagnetic wave in a microwave to millimeter-wave band has been proposed. The method has an advantage that scattering in a living body is small and energy of one photon is low, as compared with an optical method such as a method using near-infrared light.

As the method using an electromagnetic wave in the microwave to millimeter-wave band, a method using a resonance structure disclosed in Non Patent Literature 1 has been proposed. Non Patent Literature 1 discloses that a device having a high Q value, such as an antenna or a resonator, is brought into contact with a measurement sample to measure a frequency response around a resonance frequency. The resonance frequency is determined based on a complex dielectric constant around the device. Thus, the component concentration can be estimated based on a shift amount of the resonance frequency by predicting in advance a correlation between the shift amount of the resonance frequency and the component concentration.

As another method using an electromagnetic wave in the microwave to millimeter-wave band, a dielectric spectroscopy technique disclosed in Patent Literature 1 has been proposed. The dielectric spectroscopy technique irradiates a skin of a human or animal with an electromagnetic wave, causes the electromagnetic wave to be absorbed according to an interaction between blood components to be measured, for example, glucose molecules and water, and observes an amplitude and phase of the electromagnetic wave. A dielectric relaxation spectrum is calculated based on the amplitude and the phase of a frequency of the observed electromagnetic wave. The dielectric relaxation spectrum is generally expressed as a linear combination of relaxation curves based on the Cole-Cole equation, and the complex dielectric constant is calculated.

The complex dielectric constant is correlated with an amount of blood components such as glucose and cholesterol contained in blood. A calibration model can be built by measuring in advance a correlation between a change in the complex dielectric constant and the component concentration, and the component concentration can be calibrated based on a change in the measured dielectric relaxation spectrum. By using any method, improvement of measurement sensitivity can be expected by selecting a frequency band strongly correlated with a target component. This makes it necessary to measure in advance a change in dielectric constant by broadband dielectric spectroscopy.

Among the dielectric spectroscopy techniques, methods using a coaxial probe (open-ended coaxial probe or open-ended coaxial line), which are disclosed in Non Patent Literatures 2 and 3 and Patent Literature 2, can use a sample such as water which is easily available for calibrating a measuring instrument. Further, the methods can measure a dielectric constant of a measurement sample by bringing a sample to be measured into contact with an end surface of the probe, without requiring special processing of a material. Therefore, the methods are suitable for measuring a sample whose electrical characteristic is to be evaluated while avoiding processing of a living body, (sugar content of) fruit, (moisture content and conductivity of) soil, and the like.

In particular, a substrate-integrated planar coaxial sensor disclosed in Patent Literature 2 can be directly integrated on a printed circuit board (PCB) on which a dielectric spectroscopy system including a discrete IC or an ASIC is integrated and thus is suitable for building a small system such as a wearable terminal.

Non Patent Literature 4 discloses that a depth at which an electric field penetrates into a measurement target object differs depending on an opening diameter of the coaxial probe.

### CITATION LIST

### Patent Literature

Patent Literature 1: JP 2013-32933 A
Patent Literature 2: JP 6771372 B2

### Non Patent Literature

Non Patent Literature 1: M. Hofmann, G. Fischer, R. Weigel, and D. Kissinger, “Microwave-Based Noninvasive Concentration Measurements for Biomedical Applications”, IEEE Trans. Microwave Theory and Techniques, Vol. 61, No. 5, pp. 2195-2203, 2013
Non Patent Literature 2: J P. Grant, R N. Clarke, G T. SYymm and N M. Spyrou, “A critical study of the open-ended coaxial line sensor technique for RF and microwave complexpermittivity measurements”, J. Phys. E: Sci. Instrum, Vol. 22, pp. 757-770, 1989
Non Patent Literature 3: T. P. Marsland, and S. Evans “Dielectric measurements with an open-ended coaxial probe”, IEE Proceedings, Vol. 134, No. 4, 1987
Non Patent Literature 4: P.-M. Meaney, A.-P. Gregory, J. Seppälä and T. Lahtinen, “Open-Ended Coaxial Dielectric Probe Effective Penetration Depth Determination”, IEEE Trans. Microwave Theory and Techniques, Vol. 64, No. 3, pp. 915-923, 2016

### SUMMARY OF INVENTION

### Technical Problem

However, a substrate-integrated dielectric spectroscopy sensor generally has a defined substrate thickness. This makes it necessary to design a transmission line in accordance with the substrate thickness of the dielectric spectroscopy sensor. Therefore, an opening diameter of an opening provided in the substrate-integrated dielectric spectroscopy sensor is limited. Thus, a desired opening diameter cannot be set. As a result, a penetration depth at which an electric field can penetrate into a measurement target object is limited. In a case where a dielectric constant changes at a site deeper than the penetration depth, a reflection coefficient (S11 parameter) detected by the dielectric spectroscopy sensor does not change. Therefore, the dielectric constant cannot be measured with high accuracy.

The present invention has been made in view of the above circumstances, and an object thereof is to provide a dielectric spectroscopy sensor capable of measuring a dielectric constant of a measurement target object with high accuracy by increasing a penetration depth of an electric field into the measurement target object, without being limited by an opening diameter of an opening of a substrate.

### Solution to Problem

A dielectric spectroscopy sensor of the present invention is a dielectric spectroscopy sensor to be connected to a dielectric spectroscopy system, the dielectric spectroscopy sensor including: a transmission line having a predetermined characteristic impedance matching with a characteristic impedance of the dielectric spectroscopy system; a quasi-coaxial structure unit connected to the transmission line and having a first opening having a first opening diameter; and an opening diameter adjustment unit connected to the quasi-coaxial structure unit, having one end having the predetermined characteristic impedance, and having the other end serving as a second opening having a second opening diameter different from the first opening diameter.

### Advantageous Effects of Invention

According to the present invention, it is possible to measure a dielectric constant of a measurement target object with high accuracy.

### BRIEF DESCRIPTION OF DRAWINGS

FIG. 1 is a block diagram illustrating a configuration of a dielectric spectroscopy sensor according to an embodiment.

FIG. 2 is a perspective view illustrating a configuration of a dielectric spectroscopy sensor having a structure of a planar coaxial sensor.

FIG. 3A is an explanatory diagram illustrating an upper surface of a second substrate.

FIG. 3B is an explanatory diagram illustrating a lower surface of the second substrate.

FIG. 4A is an explanatory diagram illustrating an upper surface of a first substrate.

FIG. 4B is an explanatory diagram illustrating a lower surface of the first substrate.

FIG. 5A is a cross-sectional view illustrating a configuration of an opening diameter adjustment unit and illustrates an example where an inner diameter of an outer conductor 53a is constant from an upper surface toward a lower surface.

FIG. 5B is a cross-sectional view illustrating a configuration of an opening diameter adjustment unit and illustrates an example where an inner diameter of an outer conductor 53b increases stepwise from an upper surface toward a lower surface.

FIG. 5C is a cross-sectional view illustrating a configuration of an opening diameter adjustment unit and illustrates an example where an inner diameter of an outer conductor 53c decreases stepwise from an upper surface toward a lower surface.

FIG. 5D is a cross-sectional view illustrating a configuration of an opening diameter adjustment unit and illustrates an example where an inner diameter of an outer conductor 53d gradually decreases from an upper surface toward a lower surface.

FIG. 6 is an explanatory diagram illustrating an example where an opening diameter adjustment unit is formed in a quasi-coaxial shape.

FIG. 7 is a graph showing a relationship between a distance (penetration depth) from an end surface of an opening diameter adjustment unit and an electric field strength.

FIG. 8 is a graph showing a change in an S21 parameter with respect to a change in frequency when an opening diameter adjustment unit having an opening diameter of each size is used.

FIG. 9 is a graph showing a relationship between a distance (penetration depth) from an end surface of an opening diameter adjustment unit and an electric field strength.

FIG. 10 is a graph showing a change in an S21 parameter with respect to a change in frequency when an opening diameter adjustment unit 13 is not used.

### DESCRIPTION OF EMBODIMENTS

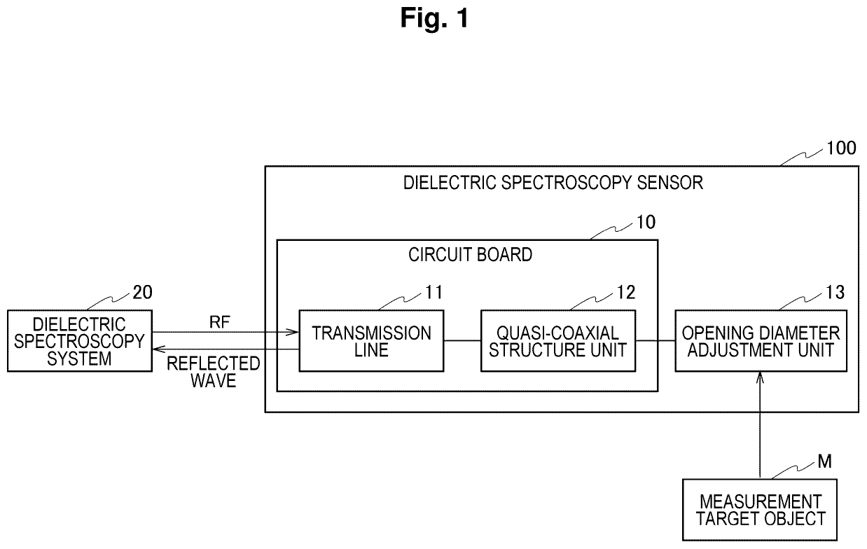

Hereinafter, embodiments of the present invention will be described with reference to the drawings. FIG. 1 is a block diagram illustrating a configuration of a dielectric spectroscopy sensor according to an embodiment of the present invention and a peripheral device thereof. As illustrated in FIG. 1, a dielectric spectroscopy sensor 100 according to the present embodiment is connected to a dielectric spectroscopy system 20 and receives a high-frequency signal (RF) output from the dielectric spectroscopy system 20. The dielectric spectroscopy sensor 100 outputs an electromagnetic wave toward a measurement target object M, receives a reflected wave thereof, and transmits the reflected wave to the dielectric spectroscopy system 20. The measurement target object M is, for example, human skin, animal, fruit, or soil.

The dielectric spectroscopy system 20 can use, for example, a general-purpose computer system including a central processing unit (CPU; processor), a memory, a storage (hard disk drive: HDD, solid state drive: SSD), a communication device, an input device, and an output device.

As illustrated in FIG. 1, a dielectric spectroscopy sensor 100 includes a transmission line 11, a quasi-coaxial structure unit 12, and an opening diameter adjustment unit 13. The transmission line 11 and the quasi-coaxial structure unit 12 are formed on a circuit board 10.

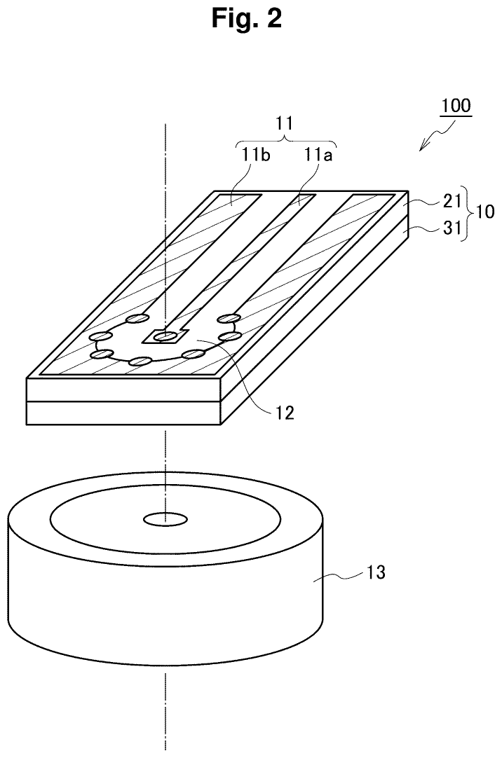

FIG. 2 is a perspective view of the dielectric spectroscopy sensor 100. As illustrated in FIG. 2, the dielectric spectroscopy sensor 100 according to the present embodiment has a configuration of a planar coaxial sensor in which a first substrate 21 and a second substrate 31 are stacked. The first substrate 21 and the second substrate 31 correspond to the circuit board 10 of FIG. 1. The first substrate 21 and the second substrate 31 may include dielectric substrates.

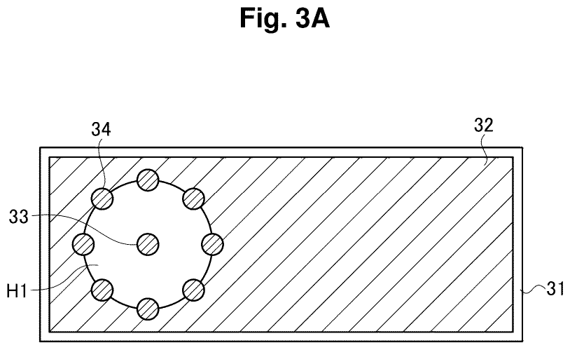

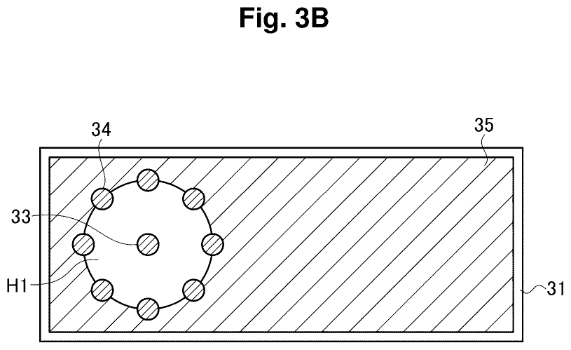

FIG. 3A is a plan view illustrating an upper surface of the second substrate 31, and FIG. 3B is a plan view illustrating a lower surface of the second substrate 31. The upper surface of the second substrate 31 is in contact with the first substrate 21, and the lower surface thereof is in contact with the opening diameter adjustment unit 13.

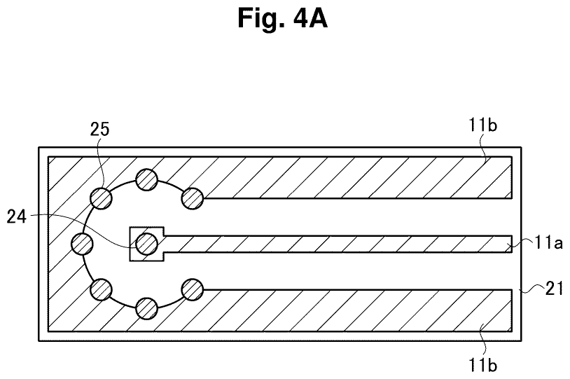

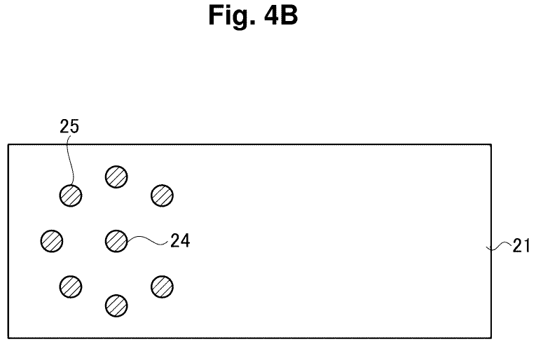

FIG. 4A is a plan view illustrating an upper surface of the first substrate 21, and FIG. 4B is a plan view illustrating a lower surface of the first substrate 21. The upper surface of the first substrate 21 is a surface on which the transmission line 11 is formed, and the lower surface thereof is in contact with the second substrate 31.

The first substrate 21 and the second substrate 31 can be made from glass epoxy, Teflon, alumina, quartz, silicon, or the like which is used at a high frequency. The first substrate 21 and the second substrate 31 have a size of, for example, several centimeters×several centimeters square and have a thickness of, for example, several hundred μm to several mm. The first substrate 21 and the second substrate 31 are, for example, dielectrics having a relative dielectric constant of 2 to 3.

As illustrated in FIGS. 3A and 3B, metal patterns 32 and 35 having a circular opening H1 (first opening) are provided on both surfaces of the second substrate 31. The opening H1 has a diameter (first opening diameter) of, for example, several hundred μm to several mm. The metal patterns 32 and 35 can be made from a metal used in a high-frequency substrate, such as Cu or Au.

A via 33 penetrating the second substrate 31 is provided at the center of the opening H1 of the second substrate 31. A plurality of (eight in FIGS. 3A and 3B) vias 34 conducted to the metal patterns 32 and 35 is provided along a circumference of the opening H1. That is, the plurality of vias 34 is provided in a circular shape around the via 33. The vias 33 and 34 are filled with a conductor.

The vias 33 and 34 can be made from a conductive ink, a copper paste, a silver paste, copper plating, or the like. Alternatively, a metal pin having the same diameter as diameters of the vias 33 and 34 may be embedded. With a quasi-coaxial structure in which the via 33 serves as an inner conductor and the vias 34 serve as outer conductors, an electromagnetic wave in a TEM mode propagates in a planar direction of the second substrate 31.

Meanwhile, as illustrated in FIG. 4A, metal patterns 11a and 11b forming coplanar lines are provided on the upper surface of the first substrate 21. The metal pattern 11a serves as a signal line of the coplanar lines, and the metal pattern 11b serves as a ground line. That is, the metal patterns 11a and 11b form the transmission line 11. Characteristic impedances of the metal patterns 11a and 11b are set to be the same as a characteristic impedance (predetermined characteristic impedance) at a connection portion of the dielectric spectroscopy system 20 in FIG. 1.

A width of the metal pattern 11a and a width of a gap between the metal patterns 11a and 11b are several tens of μm to several mm. Dimensions of the respective coplanar lines are designed to have, for example, 50Ω or 75Ω in accordance with the characteristic impedance (predetermined characteristic impedance) of the dielectric spectroscopy system 20 connected to the dielectric spectroscopy sensor 100.

In the first substrate 21, a via 24 and a plurality of vias 25 having a quasi-coaxial structure are provided corresponding to positions of the vias 33 and 34 of the second substrate 31. The via 24 is conducted to the via 33 and the metal pattern 11a. The vias 25 are conducted to the vias 34 and the metal pattern 11b. With this configuration, the first substrate 21 performs coplanar line to quasi-coax conversion. The plurality of vias 25 is arranged so as not to be in contact with the metal pattern 11a serving as the signal line. The second substrate 31 and the first substrate 21 are bonded to each other by, for example, an adhesive.

A region including the via 33, the plurality of vias 34, and the opening H1 surrounded by the vias 34 corresponds to the quasi-coaxial structure unit 12 in FIG. 1 and serves as a connection surface to be connected to the opening diameter adjustment unit 13. That is, the quasi-coaxial structure unit 12 is connected to the transmission line 11 and has the first opening having the first opening diameter. The quasi-coaxial structure unit 12 includes the metal patterns formed on the dielectric substrates (first substrate 21 and second substrate 31). Specifically, the quasi-coaxial structure unit 12 includes the vias 24 and 33 (first vias) and the vias 25 and 34 (second vias) formed on the dielectric substrates.

The transmission line 11 including the metal patterns 11a and 11b formed on the first substrate 21 can be transmission lines manufacturable on a printed circuit board or semiconductor substrate, such as a microstrip line, a coplanar line, or a coplanar strip. For example, in a case of using a microstrip line, a characteristic impedance ZMSL is shown by the following Equation (1).

$$\begin{matrix}[ Math . 1 ] & \\ {Z}_{MSL} = \frac{1}{\sqrt{{ε}_{s u b}}} \cdot 60 log [ \frac{8 h}{W} - 0.358 + \frac{1}{\frac{0.931 h}{W} + 0.736} ] & ( 1 )\end{matrix}$$

In the above Equation (1), “εsub” denotes a substrate dielectric constant of the microstrip line, and “h” denotes a substrate thickness of the circuit board 10. The sign “W” denotes a line width, that is, the width of the metal pattern 11a in FIG. 4A.

In Equation (1), the substrate dielectric constant εsub and the substrate thickness h are fixed values determined at the stage of selecting a printed circuit board or semiconductor substrate used for manufacturing the dielectric spectroscopy sensor 100. Therefore, the line width W for obtaining a desired characteristic impedance ZMSL is uniquely determined.

For example, in order to set the characteristic impedance ZMSL to approximately 50Ω by using a high-frequency substrate having a substrate thickness of approximately 200 μm and a dielectric constant of approximately 3.5, the line width W is approximately 400 μm. As disclosed in Patent Literature 2 cited above, the vias are provided in the substrate, and thus the quasi-coaxial structure is a pseudo coaxial structure including an inner conductor and an outer conductor in a direction perpendicular to a substrate, and a characteristic thereof can be regarded as equivalent to that of a coaxial line.

Here, a characteristic impedance Zcoax of the coaxial line can be shown by the following Equation (2).

$$\begin{matrix}[ Math . 2 ] & \\ {Z}_{c o a x} = \frac{138.1}{\sqrt{{ε}_{c}}} log \frac{D}{d} & ( 2 )\end{matrix}$$

In Equation (2), “εc” denotes a dielectric constant of an inner dielectric of the coaxial line, “D” denotes an inner diameter of the outer conductor forming the coaxial line, and “d” denotes an outer diameter of the inner conductor.

As is clear from Equation (2), in a case where the dielectric constant of the circuit board 10 is determined, and a ratio “D/d” of the outer diameter D to the inner diameter d does not change, the characteristic impedance of the coaxial line does not change. The characteristic impedance is generally designed to be 50Ω, and the ratio “D/d” is approximately 0.2 in a case where the substrate dielectric constant is approximately 3.5.

In a case where a coaxial-probe dielectric spectroscopy sensor is used, one end surface of the coaxial line serves as an open end that can be brought into contact with the measurement target object M, and, by generating an electric field in the measurement target object M that is in contact with the open end, an S11 parameter is calculated based on a reflected wave by the electric field. The dielectric spectroscopy system 20 measures a dielectric constant of the measurement target object based on a change in the S11 parameter. At this time, a depth at which the electric field penetrates into the measurement target object M changes depending on an opening diameter of the open end.

The “penetration depth” is a depth at which the electric field penetrates into the measurement target object M by using an electromagnetic wave output from a measurement surface of the dielectric spectroscopy sensor 100. In a case where the dielectric constant changes at a site deeper than the penetration depth, the S11 parameter of the coaxial sensor does not change because the electric field does not reach the site. Therefore, it is necessary to secure a sufficient penetration depth in thin film measurement and measurement of a living body such as a cell.

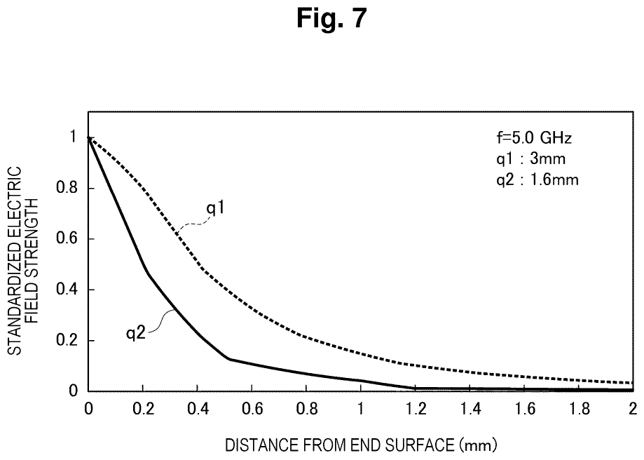

FIG. 7 is a graph showing a relationship between a distance (penetration depth) from an end surface of the measurement target object M and a standardized electric field strength when the opening diameter adjustment unit 13 according to the present embodiment is not used. A frequency f is 5.0 GHz. A curve q1 in FIG. 7 is a graph when the opening diameter is 3 mm, and a curve q2 is a graph when the opening diameter is 1.6 mm. It is found from the curves q1 and q2 that the penetration depth of the electric field is larger when the opening diameter is 3 mm.

That is, the penetration depth of the electric field is related to an electric field strength distribution from an end surface of the coaxial sensor, and attenuation of the electric field is smaller as the opening diameter is larger, and thus the electric field reaches deeper. Therefore, in order to design a dielectric spectroscopy sensor having a desired penetration depth, it is only necessary to adjust an opening diameter of an end surface of the dielectric spectroscopy sensor. When the opening diameter adjustment unit 13 includes a coaxial line and the ratio “D/d” is set, it is possible to match a characteristic impedance of the quasi-coaxial structure unit 12 with a characteristic impedance of a connection surface of the opening diameter adjustment unit 13, the connection surface being connected to the quasi-coaxial structure unit 12.

In the present embodiment, when the opening diameter adjustment unit 13 having a coaxial structure is provided on an end surface (corresponding to the opening H1 in FIGS. 3A and 3B) of the quasi-coaxial structure unit 12, the transmission line is converted into the coaxial line in the quasi-coaxial structure unit 12, thereby changing an opening diameter of the coaxial line in the opening diameter adjustment unit 13. Therefore, it is possible to achieve both a broadband transmission characteristic and a degree of freedom in design of the penetration depth.

The opening diameter of the opening diameter adjustment unit 13 may be larger or smaller than the opening diameter of the quasi-coaxial structure unit 12 (diameter of the opening H1). At this time, the transmission line 11, the quasi-coaxial structure unit 12, and the opening diameter adjustment unit 13 are designed to have the same characteristic impedance. Hereinafter, a specific configuration of the opening diameter adjustment unit 13 will be described.

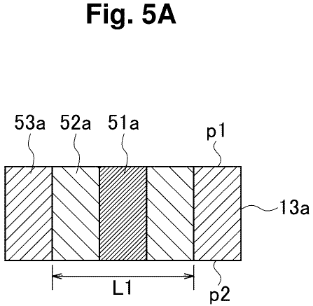

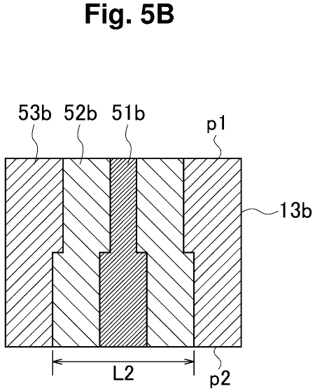

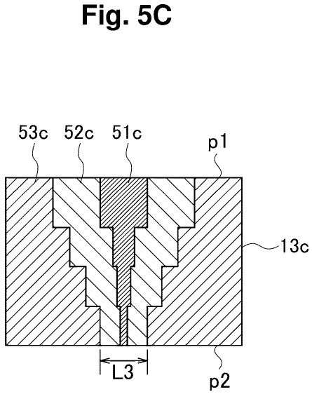

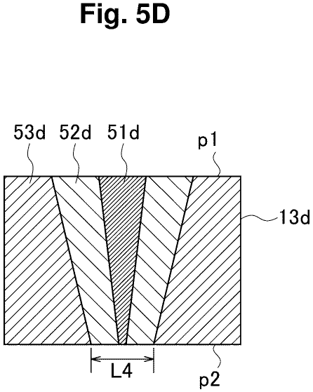

FIGS. 5A to 5D are cross-sectional views illustrating specific examples of the opening diameter adjustment unit 13. Opening diameter adjustment units 13a to 13d in FIGS. 5A to 5D, respectively, have a cylindrical shape, and an upper end p1 is a surface in contact with the measurement surface of the circuit board 10, and a lower end p2 is a surface to be brought into contact with the measurement target object M.

The opening diameter adjustment unit 13a in FIG. 5A has a coaxial probe structure including an inner conductor 51a, a dielectric 52a concentrically formed around the inner conductor 51a, and an outer conductor 53a concentrically formed around the dielectric 52a. The inner conductor 51a and the outer conductor 53a have the same diameter from the upper end p1 toward the lower end p2. That is, in the example of FIG. 5A, the opening diameter adjustment unit 13a is such that an opening diameter of an opening at one end is the same as an opening diameter thereof at the other end. With such a configuration, the opening diameter of the measurement surface (inner diameter of the outer conductor 53a) to be brought into contact with the measurement target object M can be set to L1 (>H1) which is different from the diameter of the opening H1 in FIGS. 3A and 3B.

The opening diameter adjustment unit 13b in FIG. 5B includes an inner conductor 51b, a dielectric 52b concentrically formed around the inner conductor 51b, and an outer conductor 53b concentrically formed around the dielectric 52b. The inner conductor 51b has a diameter that increases stepwise from the upper end p1 toward the lower end p2. That is, in the example of FIG. 5B, the opening diameter adjustment unit 13b is such that the opening diameter of the opening at one end is different from the opening diameter thereof at the other end, and the opening diameter changes so as to increase stepwise from the one end toward the other end. With such a configuration, the opening diameter of the measurement surface to be brought into contact with the measurement target object M can be set to L2 (>H1) which is different from the diameter of the opening H1.

The opening diameter adjustment unit 13c in FIG. 5C includes an inner conductor 51c, a dielectric 52c concentrically formed around the inner conductor 51c, and an outer conductor 53c concentrically formed around the dielectric 52c. The inner conductor 51c has a diameter that decreases stepwise from the upper end p1 toward the lower end p2. That is, in the example of FIG. 5C, the opening diameter adjustment unit 13c is such that the opening diameter of the opening at one end is different from the opening diameter thereof at the other end, and the opening diameter changes so as to decrease stepwise from the one end toward the other end. With such a configuration, the opening diameter of the measurement surface to be brought into contact with the measurement target object M can be set to L3 (<H1) which is different from the diameter of the opening H1.

The opening diameter adjustment unit 13d in FIG. 5D includes an inner conductor 51d, a dielectric 52d concentrically formed around the inner conductor 51d, and an outer conductor 53d concentrically formed around the dielectric 52d. The inner conductor 51d has a diameter that continuously decreases from the upper end p1 toward the lower end p2. That is, in the example of FIG. 5D, the opening diameter adjustment unit 13d is such that the opening diameter of the opening at one end is different from the opening diameter thereof at the other end, and the opening diameter gradually changes from the one end toward the other end. With such a configuration, the opening diameter of the measurement surface to be brought into contact with the measurement target object M can be set to L4 (<H1) which is different from the diameter of the opening H1.

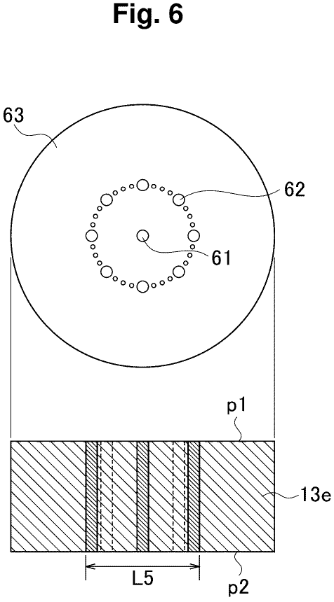

FIG. 6 is an explanatory diagram illustrating an example where the opening diameter adjustment unit 13 is formed in a quasi-coaxial shape. An opening diameter adjustment unit 13e in FIG. 6 has a cylindrical shape, and an inner conductor 61 is formed at the center thereof, whereas a plurality of (eight in FIG. 6) outer conductors 62 is provided on a circle centered on the inner conductor 61. The inner conductor 61 is provided corresponding to the position of the via 33 in FIGS. 3A and 3B. The outer conductors 62 are provided at positions outside or inside the positions of the vias 34 in FIGS. 3A and 3B. With such a configuration, the opening diameter of the measurement surface to be brought into contact with the measurement target object M can be set to L5 (<H1) which is different from the diameter of the opening H1.

That is, the opening diameter adjustment unit 13 is connected to the quasi-coaxial structure unit 12, has one end (upper end p1) having a predetermined characteristic impedance, and has the other end (lower end p2) serving as a second opening having the opening diameters L1 to L5 (second opening diameters) which are different from the opening diameter (first opening diameter) of the opening H1.

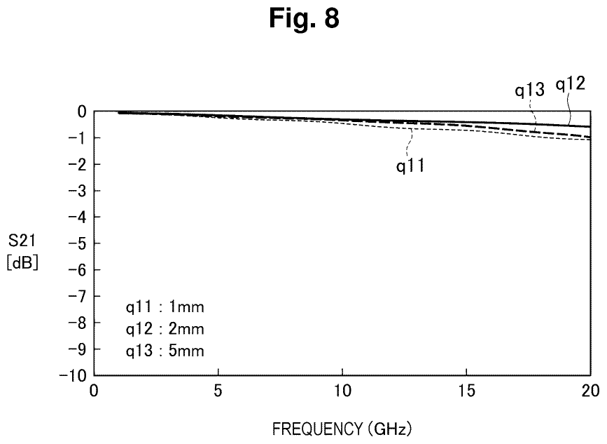

FIG. 8 is a graph showing a change in an S21 parameter with respect to a change in frequency in a case where a high-frequency substrate having a substrate thickness of 200 μm and a dielectric constant of approximately 3.5 is used, the opening diameter of the quasi-coaxial structure unit 12 is set to 2 mm, and the straight structure of FIG. 5A is used as the opening diameter adjustment unit 13. The “S21 parameter” indicates a pass characteristic from one point to another point which are arbitrarily set.

A curve q12 is a graph in a case where the opening of the quasi-coaxial structure unit is 2 mm. A curve q11 is a graph in a case where the opening diameter of the opening diameter adjustment unit 13 is 1 mm that is half the length of the opening of the quasi-coaxial structure unit. A curve q13 is a graph in a case where the opening diameter of the opening diameter adjustment unit 13 is 5 mm that is 2.5 times the length of the opening of the quasi-coaxial structure unit.

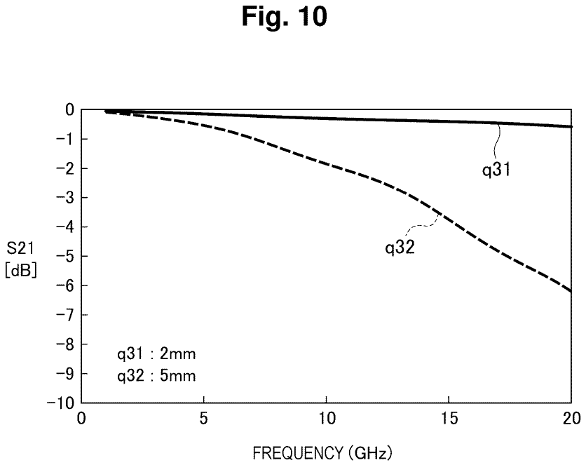

FIG. 10 is a graph showing a change in the S21 parameter with respect to a change in frequency when the opening diameter of the opening of the planar coaxial sensor is set to 2 mm and 5 mm, without using the opening diameter adjustment unit 13. In FIG. 10, in a curve q31 having the opening diameter of 2 mm, the S21 parameter does not greatly change with respect to the change in frequency. However, in a curve q32 having the opening diameter of 5 mm, the S21 parameter greatly decreases as the frequency increases.

Meanwhile, in the graph of FIG. 8, it is found that an electromagnetic wave is efficiently transmitted to the end surface of the probe of the coaxial probe structure in both the curves q11 and q13. Because the electromagnetic wave is efficiently transmitted to the end surface of the probe, an influence of loss caused by a reflection point is reduced, which makes it possible to enhance measurement sensitivity of a reflection characteristic.

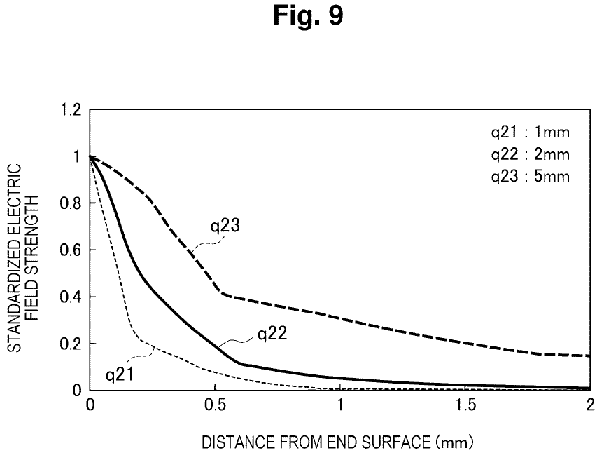

FIG. 9 is a graph showing an electric field strength distribution from the end surface of the opening diameter adjustment unit 13 in the same design as that of FIG. 8. A curve q21 in FIG. 9 shows a case where the opening diameter is 1 mm, a curve q22 shows a case where the opening diameter is 2 mm, and a curve q23 shows a case where the opening diameter is 5 mm. From the curves q21, q22, and q23, it is found that the penetration depth is deeper as the opening diameter is larger.

In the dielectric spectroscopy sensor 100 according to the present embodiment, it is possible to set the penetration depth of the electric field into the measurement target object M to a desired penetration depth and to accurately measure the reflection characteristic of the measurement target object in a wide frequency band. Based on the measured reflection characteristic, the dielectric constant of the measurement target object M is obtained by the following calculation.

A calibration standard and the measurement target object M are placed on the end surface of the opening diameter adjustment unit 13 having the coaxial probe structure, and reflected waves are measured when electromagnetic waves are output to the calibration standard and the measurement target object, thereby calculating the dielectric constant of the measurement target object M by using the following Equations (3) and (4).

$$\begin{matrix}[ Math . 3 ] & \\ \frac{( {ρ}_{m} - {ρ}_{1} ) ( {ρ}_{3} - {ρ}_{2} )}{( {ρ}_{m} - {ρ}_{2} ) ( {ρ}_{1} - {ρ}_{3} )} = \frac{( {y}_{m} - {y}_{1} ) ( {y}_{3} - {y}_{2} )}{( {y}_{m} - {y}_{2} ) ( {y}_{1} - {y}_{3} )} & ( 3 )\end{matrix}$$

$$\begin{matrix}[ Math . 4 ] & \\ {y}_{i} = {ε}_{i} + \frac{{G}_{0}}{j ω {C}_{0}} {ε}_{i}^{5 / 2} ( i = 1 , 2 , 3 , 4 , m ) & ( 4 )\end{matrix}$$

In Equations (3) and (4), “p” denotes a corrected reflection coefficient S11, “y” denotes a linear mapping of the admittance, “ε” denotes the dielectric constant of the measurement target object M, “GO” denotes a conductance of the coaxial probe in vacuum, and “CO” denotes a capacitance of the coaxial probe in vacuum. Subscripts “1” to “4” denote calibration standards, and “m” denotes the measurement target object.

The measured dielectric constant can be used for material evaluation, a chronological change in the characteristic of the measurement target object M, quantification of biological component concentration, and the like. The ratio of “D/d” may be changed by using a material having a dielectric constant different from that of the circuit board 10.

In the conventional method disclosed in Patent Literature 2 cited above, the dielectric spectroscopy sensor does not include the opening diameter adjustment unit 13 that is a feature of the present embodiment and includes only the connection transmission line and the quasi-coaxial structure unit. Therefore, in order to change the penetration depth of the electric field, it is necessary to increase the opening diameter of the quasi-coaxial structure unit.

At this time, an electromagnetic wave in the TEM mode transmitted by a microstrip line or coplanar line passes through a gap of the order of 100 μm, and thus, in a case where the opening diameter of the quasi-coaxial structure unit is extremely large, the quasi-coaxial structure unit exhibits a characteristic close to an open end, and the electromagnetic wave is reflected on an interface between the transmission line and the quasi-coaxial structure unit.

For example, as the pass characteristic that is obtained when a microstrip line having a line width of 400 μm is used as the transmission line, the microstrip line side serves as a first port, and an end surface of the quasi-coaxial structure unit serves as a second port, as shown in FIG. 10, the transmission characteristic of the electromagnetic wave significantly deteriorates in a case where the opening diameter is large.

Meanwhile, in the present embodiment, the opening diameter adjustment unit 13 is provided in addition to the transmission line 11 and the quasi-coaxial structure unit 12, and the characteristic impedance of the end surface of the coaxial probe structure in the opening diameter adjustment unit 13 is designed to match with the characteristic impedance of the transmission line 11. This makes it possible to reduce reflection on each interface.

As described above, the dielectric spectroscopy sensor 100 according to the present embodiment is the dielectric spectroscopy sensor 100 to be connected to the dielectric spectroscopy system 20, which includes: the transmission line 11 having a predetermined characteristic impedance matching with a characteristic impedance of the dielectric spectroscopy system 20; the quasi-coaxial structure unit 12 connected to the transmission line 11 and having the first opening having the first opening diameter; and the opening diameter adjustment unit 13 connected to the quasi-coaxial structure unit 12, having one end having the predetermined characteristic impedance, and having the other end serving as the second opening having the second opening diameter different from the first opening diameter.

In the dielectric spectroscopy sensor 100 according to the present embodiment, it is possible to arbitrarily set the opening diameter of the opening to be brought into contact with the measurement target object M by providing the opening diameter adjustment unit 13. As a result, the penetration depth of the electric field can be increased, and, even in a case where the dielectric constant of the measurement target object M changes at a deeper site, it is possible to detect the change in the dielectric constant with high accuracy.

Because the transmission line 11 and the quasi-coaxial structure unit 12 include metal patterns formed on the first substrate 21 and the second substrate 31 that are dielectric substrates, it possible to reduce a size and thickness of the dielectric spectroscopy sensor 100.

The quasi-coaxial structure unit 12 includes the first via (vias 24 and 33) formed at the center of the circular opening formed in the first substrate 21 and the second substrate 31 (dielectric substrates) and the plurality of second vias (vias 25 and 34) formed along the circumference of the opening H1. This makes it possible to simply form the quasi-coaxial structure unit 12 and to reduce a size of the dielectric substrates.

In the present embodiment, as illustrated in FIG. 5A, the opening diameter adjustment unit 13 is such that the opening diameter of the opening at one end is the same as the opening diameter thereof at the other end. Therefore, the opening diameter L1 in FIG. 5A is different from the opening diameter of the opening H1 in FIGS. 3A and 3B. Therefore, the opening diameter of the opening diameter adjustment unit 13 can be set to an arbitrary opening diameter, and thus the penetration depth of the electric field can be increased. As a result, it is possible to improve measurement accuracy of the dielectric spectroscopy sensor 100.

In the present embodiment, as illustrated in FIGS. 5B and 5C, the opening diameter of the opening diameter adjustment unit 13 changes stepwise from one end toward the other end. Therefore, the opening diameter of the opening diameter adjustment unit 13 can be set to an arbitrary opening diameter, and thus the penetration depth of the electric field can be increased. As a result, it is possible to improve measurement accuracy of the dielectric spectroscopy sensor 100.

In the present embodiment, as illustrated in FIG. 5D, the opening diameter of the opening diameter adjustment unit 13 gradually changes from one end toward the other end. Therefore, the opening diameter of the opening diameter adjustment unit 13 can be set to an arbitrary opening diameter, and thus the penetration depth of the electric field can be increased. As a result, it is possible to improve measurement accuracy of the dielectric spectroscopy sensor 100.

In the present embodiment, as illustrated in FIG. 6, the opening diameter adjustment unit 13 having a quasi-coaxial cable shape is used. Therefore, the opening diameter of the opening diameter adjustment unit 13 can be set to an arbitrary opening diameter, and thus the penetration depth of the electric field can be increased. As a result, it is possible to improve measurement accuracy of the dielectric spectroscopy sensor 100.

In the present embodiment, the opening diameter adjustment unit 13, which has a coaxial probe structure having a broadband and arbitrary penetration depth suitable for measuring a thin layer substrate, a cell, a biological sample, and the like, is mounted on a dielectric substrate having a defined substrate thickness and defined dielectric constant. This makes it possible to measure the dielectric constant of the measurement target object M with high accuracy.

The present invention is not limited to the above embodiments, and various modifications can be made within the scope of the gist of the present invention.

### REFERENCE SIGNS LIST

10 Circuit board
11 Transmission line
11a, 11b Metal pattern
12 Quasi-coaxial structure unit
13, 13a to 13e Opening diameter adjustment unit
20 Dielectric spectroscopy system
21 First substrate
24, 33 Via (first via)
25, 34 Via (second via)
31 Second substrate
32, 35 Metal pattern
51a, 51b, 51c, 51d Inner conductor
52a, 52b, 52c, 52d Dielectric
53a, 53b, 53c, 53d Outer conductor
61 Inner conductor
62 Outer conductor
100 DIELECTRIC SPECTROSCOPY SENSOR
M Measurement target object

1. A dielectric spectroscopy sensor to be connected to a dielectric spectroscopy system, the dielectric spectroscopy sensor comprising:
a transmission line having a predetermined characteristic impedance matching with a characteristic impedance of the dielectric spectroscopy system;
a quasi-coaxial structure unit connected to the transmission line and having a first opening having a first opening diameter; and
an opening diameter adjustment unit connected to the quasi-coaxial structure unit, having one end having the predetermined characteristic impedance, and having the other end serving as a second opening having a second opening diameter different from the first opening diameter.

2. The dielectric spectroscopy sensor according to claim 1, wherein
the transmission line and the quasi-coaxial structure unit include a metal pattern formed on a dielectric substrate.

3. The dielectric spectroscopy sensor according to claim 2, wherein
the quasi-coaxial structure unit has
a first via formed at a center of a circular opening formed in the dielectric substrate, and
a plurality of second vias formed along a circumference of the opening.

4. The dielectric spectroscopy sensor according to claim 1, wherein
the opening diameter adjustment unit is such that the opening diameter of the opening at the one end is the same as the opening diameter at the other end.

5. The dielectric spectroscopy sensor according to claim 1, wherein
the opening diameter adjustment unit is such that the opening diameter of the opening at the one end is different from the opening diameter at the other end, and the opening diameter gradually changes from the one end toward the other end.

6. The dielectric spectroscopy sensor according to claim 1, wherein
the opening diameter adjustment unit is such that the opening diameter of the opening at the one end is different from the opening diameter at the other end, and the opening diameter changes stepwise from the one end toward the other end.

7. The dielectric spectroscopy sensor according to claim 1, wherein
the opening diameter adjustment unit has a quasi-coaxial cable shape.

8. The dielectric spectroscopy sensor according to claim 2, wherein
the opening diameter adjustment unit is such that the opening diameter of the opening at the one end is the same as the opening diameter at the other end.

9. The dielectric spectroscopy sensor according to claim 3, wherein
the opening diameter adjustment unit is such that the opening diameter of the opening at the one end is the same as the opening diameter at the other end.

10. The dielectric spectroscopy sensor according to claim 2, wherein
the opening diameter adjustment unit is such that the opening diameter of the opening at the one end is different from the opening diameter at the other end, and the opening diameter gradually changes from the one end toward the other end.

11. The dielectric spectroscopy sensor according to claim 3, wherein
the opening diameter adjustment unit is such that the opening diameter of the opening at the one end is different from the opening diameter at the other end, and the opening diameter gradually changes from the one end toward the other end.

12. The dielectric spectroscopy sensor according to claim 2, wherein
the opening diameter adjustment unit is such that the opening diameter of the opening at the one end is different from the opening diameter at the other end, and the opening diameter changes stepwise from the one end toward the other end.

13. The dielectric spectroscopy sensor according to claim 3, wherein
the opening diameter adjustment unit is such that the opening diameter of the opening at the one end is different from the opening diameter at the other end, and the opening diameter changes stepwise from the one end toward the other end.

14. The dielectric spectroscopy sensor according to claim 2, wherein
the opening diameter adjustment unit has a quasi-coaxial cable shape.

15. The dielectric spectroscopy sensor according to claim 3, wherein
the opening diameter adjustment unit has a quasi-coaxial cable shape.
